(19) United States
(12) Patent Application Publication
(10) Pub. No.: US 2007/0152843 A1
(43) Pub. Date: Jul. 5, 2007

(54) Remote Snooze Button for Alarm Devices

(76) Inventor: Zeynep Ucer Bursal, Lexington, MA (US)

Correspondence Address: ZEYNEP BURSAL, 32 ADAMS STREET, LEXINGTON, MA, 02420, US

(21) Appl. No.: 11/617,702

(22) Filed: Dec. 28, 2006

Related U.S. Application Data
(60) Provisional application No. 60/766,099, filed on Dec. 30, 2005.

(51) Int. Cl. G05B 19/02

(52) U.S. Cl. 340/825.24

(57) ABSTRACT

An apparatus is provided for remotely and temporarily turning off a wake-up alarm on a target device. The apparatus includes a dedicated, large and ergonomic “snooze” button that is easy to operate, and can control a selected target device among a plurality of possibilities.

### BACKGROUND OF THE INVENTION

The present invention relates to devices incorporating a wake-up alarm function, and more particularly, to temporarily silencing the alarm on clock radios and music systems.

Alarm devices for waking up a person, so that he or she will be on time for work, school, travel and the like, provide a common and useful function. In addition to being incorporated into clocks, such devices are also increasingly offered as part of audio entertainment systems. The user then has the choice of waking up to a desired radio station or other entertainment source, as an alternative to the more common buzzer-type alarm. Most alarm devices incorporate a “snooze” button, the purpose of which is to ease the user into wakefulness by allowing a ringing alarm to be temporarily suspended. The alarm starts again after a prescribed period of time, typically a few minutes. Generally, the user is still in bed, and not yet fully awake, when operating a snooze button; therefore, devices with snooze buttons are placed within easy reach of the bed.

On the other hand, it is well known that furniture arrangements and acoustic considerations dictate where an audio entertainment system is best located in a given room. In many cases, the system is located far enough away from the bedside that operating a snooze button on the device itself is impossible while still in bed. For this reason, as well as for the more general purpose of giving the user the option of controlling other aspects of the entertainment system from afar, many audio devices that include an alarm function come with a remote control incorporating all or many of the device controls. A snooze button is typically also found on such remote controls, but it is one button among many, and is generally too small to locate and depress without looking carefully, a task ill-suited to less than full wakefulness.

Finally, it is noted that, in addition to the original remote control that comes with a particular entertainment system, so-called universal remote controls are now available, which are capable of mimicking the control codes that the original remote sends out. Most universal remotes come pre-programmed with the control codes of a plurality of entertainment devices, so that the user selects his or her particular system from a list of choices during an initial set-up process, in order to allow the universal remote to control it. Other universal remotes can be directly “taught” to replicate each control code sent out by the original remote control. Some universal remotes use a combination of the two approaches. In any event, a universal remote control suffers the same drawbacks with respect to a snooze button (if one even exists) as the corresponding original remote control, as noted above: one button among many, which is difficult to locate, identify and depress while not yet fully awake.

It is therefore an object of the present invention to provide a remote snooze button that is easy to operate while in bed.

It is a further object of the present invention to provide a dedicated snooze button that is not easily confused with other buttons in close proximity.

It is an additional object of the present invention to provide a snooze button that helps the user wake up more gently, by not requiring the user to open his/her eyes to read button labels in order to identify and depress the correct button on a remote control.

It is yet an additional object of the present invention to provide a snooze button that is customizable to remotely control any one of a plurality of different makes and models of entertainment devices that incorporate an alarm function.

### SUMMARY OF THE INVENTION

These and other objects are well met by the presently disclosed, dedicated, simple, customizable and robust remote snooze button device.

A preferred embodiment includes a large, ergonomically shaped single button that is easy to locate and depress even when one is not fully awake. This single button momentarily closes a switch, which then causes an appropriate infrared or radio frequency signal to be sent to the device whose alarm is going off, causing the alarm to be temporarily suspended.

A microprocessor inside the device responds to the closing of the switch and generates a series of voltage pulses of appropriate duration, so that a connected infrared transmitting diode, plurality of diodes or radio frequency transmitter sends out a coded signal that the target alarm device can correctly identify as a “snooze” command. In various embodiments, the user can perform a one-time setup by means of switches and the like, to customize the output of the remote snooze button to the particular alarm device being controlled. The setup process may also incorporate a learning feature, whereby the remote snooze button stores the original device's remote snooze code for later reproduction of the same. In some instances, a variant of the customization process may take place, which does not involve the end user and whereby a particular control code among several possibilities is recorded into the memory of the device at a factory, distribution center or dealership. This may involve what is commonly referred to as “flashing.” Whatever the particular circumstances, once set up, the remote snooze button always sends out the same, unique infrared or radio frequency control signal each time it is actuated. In a preferred embodiment of the invention, a battery within the device provides the power necessary for generating and emitting the control signals.

### BRIEF DESCRIPTION OF THE DRAWINGS

These and other features and advantages of the present invention will be more fully understood by reference to the following detailed description in conjunction with the attached drawing, in which like reference numerals refer to like elements and in which:

FIG. 1 shows the basic construction of the remote snooze button.

FIG. 2 shows the actuation a preferred embodiment of the remote snooze button by a user, causing the device to emit an infrared signal that is sent to the target alarm device.

FIG. 3 shows the actuation an alternative embodiment of the remote snooze button by a user, causing the device to emit a radio frequency signal that is sent to the target alarm device.

FIG. 4 is a schematic diagram showing the major components of a preferred embodiment of the invention, whereby an infrared control signal is generated and sent.

FIG. 5 is a schematic diagram showing the major components of an alternative embodiment of the invention, whereby a radio frequency control signal is generated and sent.

FIG. 6 is a schematic diagram showing the major components of yet another alternative embodiment of the invention, whereby an infrared control signal is captured, then replicated and sent.

FIG. 7 is a schematic diagram showing the major components of an alternative embodiment of the invention, where a mechanical-to-electrical power converter device is used to power the generation and emission of an infrared control signal directly from the mechanical actuation of the button by the user.

FIG. 8 is a schematic diagram showing the major components of an alternative embodiment of the invention, where a mechanical-to-electrical power converter device is used to power the generation and emission of a radio frequency control signal directly from the mechanical actuation of the button by the user.

FIG. 9 shows the underside of a preferred embodiment of the remote snooze button, where a series of discrete switches is used to select the make and model of the target alarm device from a list of supported devices, or to directly enter a key code that customizes the sent control code to the make and model of the target alarm device.

FIG. 10 shows the underside of an alternative embodiment of the remote snooze button, where a rotary knob is used to select the make and model of the target alarm device from a list of supported devices.

FIG. 11 shows the underside of yet another alternative embodiment of the remote snooze button, where a solid-state memory card is inserted into the device in order to customize the sent control code to the make and model of the target alarm device.

FIG. 12 shows the underside of still another alternative embodiment of the remote snooze button, where a setup switch places the device into and out of “learning” mode.

FIG. 13 is a schematic diagram illustrating an alternative embodiment of the remote snooze button, which includes a visible light source in addition to the remote control components.

### DETAILED DESCRIPTION OF A PREFERRED EMBODIMENT

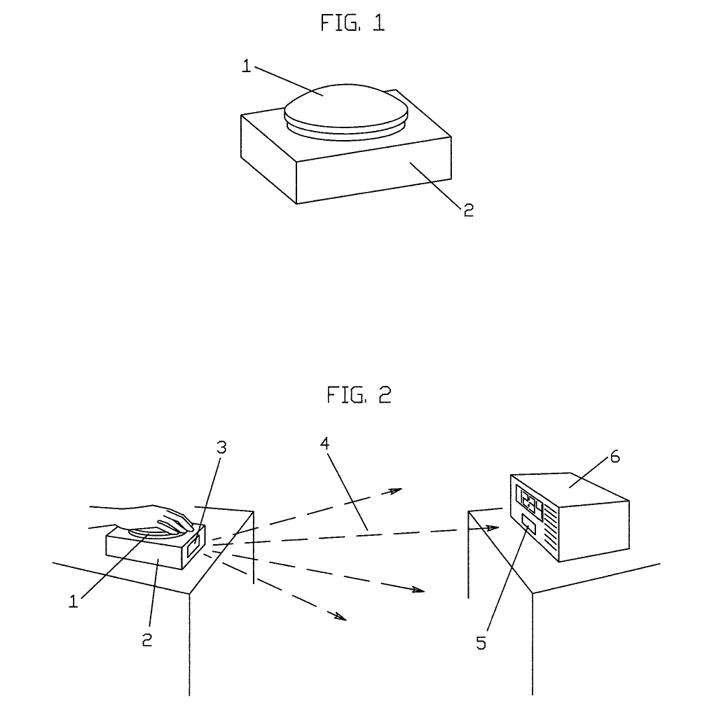

The basic construction of the remote snooze button is shown in FIG. 1. A large, ergonomically shaped single button 1 is located on top of housing 2, which contains all of the other components required for the device to perform its functions. Button 1 is designed to be able to be easily depressed manually, and to return to its original state once the manual input is removed.

FIG. 2 shows the actuation of a preferred embodiment of the remote snooze button of the present invention, so that an infrared control signal is sent to a target device. The user manually depresses button 1 located on top of housing 2. As will be explained below, this action momentarily closes a switch inside the device, causing an infrared signal to be generated an emitted. A transmissive window 3 permits infrared rays 4 to travel to a similarly transmissive window 5 on the target device 6, so that an alarm that is going off on the target device 6 is temporarily silenced.

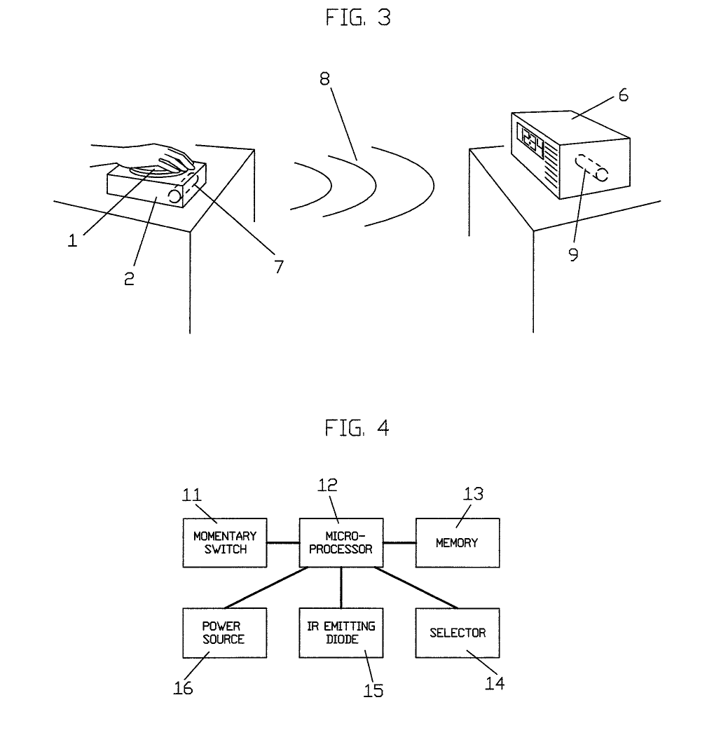

FIG. 3 shows the actuation of an alternative embodiment of the remote snooze button of the present invention, so that a radio frequency control signal is sent to a target device. The user manually depresses button 1 located on top of a housing 2 that is transmissive to radio frequency waves. As will be explained further below, this action momentarily closes a switch inside the device, causing a radio frequency signal to be generated and transmitted by an antenna 7. The radio frequency waves 8 travel to a receiving antenna 9 on the target device 6, so that an alarm that is going off on the target device 6 is temporarily silenced.

A schematic diagram is given in FIG. 4 for the means whereby an infrared control signal is sent to target device 6. Ancillary electronic components that would also be used, such as resistors, capacitors and the like, are omitted from the picture. As the user manually depresses aforementioned button 1, switch 11 is momentarily closed. A microprocessor 12 senses the closing of switch 11 and generates a series of voltage pulses of appropriate duration, in accordance with data contained in memory 13. A selector mechanism 14 is operated once during initial setup of the remote snooze button device of the present invention. In conjunction with data contained in memory 13, the settings of selector 14 influence the code that microprocessor 12 generates for appropriate control of target device 6. The voltage pulses thus generated cause an infrared diode, or plurality of diodes, 15 to emit a remote control signal that target device 6 can interpret as a “snooze” command. An electrical power source 16, such as a battery, provides the required power to perform the generation and emission of this control signal.

Similarly, a schematic diagram is given in FIG. 5 for the means whereby a radio frequency control signal is sent to target device 6. As the user manually depresses aforementioned button 1, switch 11 is momentarily closed. A microprocessor 12 senses the closing of switch 11 and generates a series of voltage pulses of appropriate duration, in accordance with data contained in memory 13. A selector mechanism 14 is operated once during initial setup of the remote snooze button device of the present invention. In conjunction with data contained in memory 13, the settings of selector 14 influence the code that microprocessor 12 generates for appropriate control of target device 6. The voltage pulses thus generated cause a radio frequency antenna 17 to transmit a remote control signal that target device 6 can interpret as a “snooze” command. An electrical power source 16, such as a battery, provides the required power to perform the generation and transmission of this control signal.

It is noted here that the embodiments shown in FIGS. 4 and 5 can be realized in the absence of a visible selector 14 if the remote snooze button is to send out one pre-assigned code in response to the pressing of button 1. In that instance, the selection of a particular control code among several possibilities is to be understood as the selective loading thereof into the memory of the remote snooze button. This may occur in a variety of ways. For instance, “flashing” at a factory, distribution center or dealership may customize the control code to a particular target device, such that the user need not be involved in the selection process. Alternatively, a memory card or stick may be physically loaded into the remote snooze button to achieve the same end result. Inasmuch as a target device selection is still being effected, such possibilities are all within the spirit of the present invention as providing for customization.

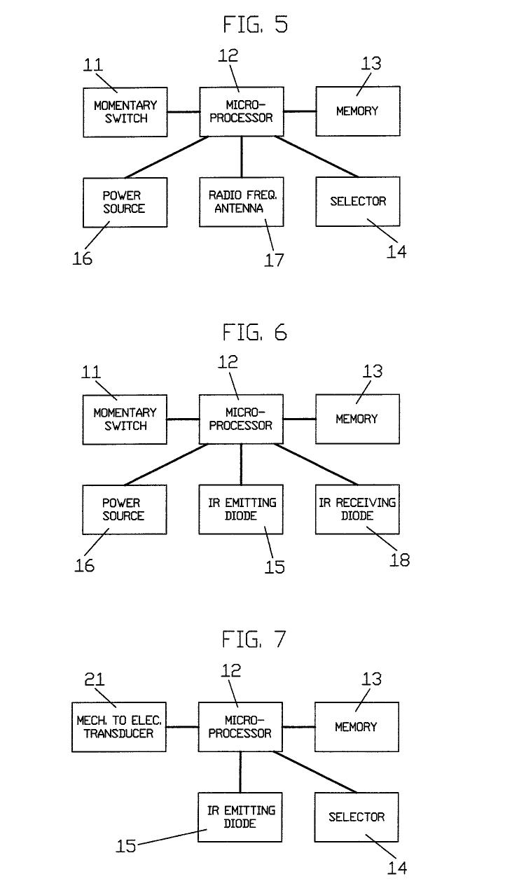

An alternative schematic diagram is given in FIG. 6 for the means whereby an infrared control signal is sent to target device 6. As the user manually depresses aforementioned button 1, switch 11 is momentarily closed. A microprocessor 12 senses the closing of switch 11 and generates a series of voltage pulses of appropriate duration, in accordance with target device-specific data contained in memory 13. In this embodiment of the invention, an infrared receiving diode 18 is used once to “teach” the desired control code to the remote snooze button. The microprocessor 12 decodes the arriving signal and stores the code in memory 13, which is then replicated each time button 1 is pressed, for appropriate control of target device 6. The voltage pulses generated by the microprocessor cause an infrared diode, or plurality of diodes, 15 to emit a remote control signal that target device 6 can interpret as a “snooze” command. An electrical power source 16, such as a battery, provides the required power to perform the generation and emission of this control signal.

FIG. 7 shows a schematic diagram of another embodiment of the present invention, in which mechanical to electrical transduction is used to power the generation and emission of an infrared control signal, in the absence of a battery or other available electrical power source. As the user manually depresses aforementioned button 1, the attendant mechanical work is converted to electrical power by known means 21, such as a piezoelectric crystal or electromagnetic generator. A microprocessor 12 senses the resulting input voltage and generates a series of voltage pulses of appropriate duration, in accordance with data contained in memory 13. A selector mechanism 14 is operated once during initial setup of the remote snooze button device of the present invention. In conjunction with data contained in memory 13, the settings of selector 14 influence the code that microprocessor 12 generates for appropriate control of target device 6. The voltage pulses thus generated cause an infrared diode, or plurality of diodes, 15 to emit a remote control signal that target device 6 can interpret as a “snooze” command. The required power for the generation and emission of this control signal is also provided by transduction means 21. It will be obvious to those skilled in the art that transduction means 21 would generally also incorporate means for temporary energy storage and power regulation.

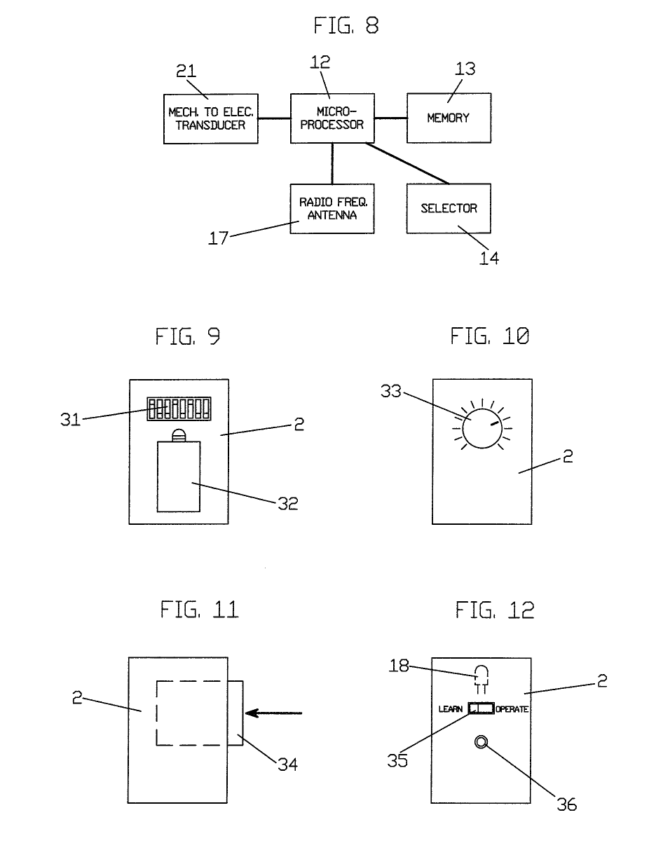

Similarly, FIG. 8 shows a schematic diagram of an alternative embodiment of the present invention, in which mechanical to electrical transduction is used to power the generation and transmission of a radio frequency control signal, in the absence of a battery or other available electrical power source. As the user manually depresses aforementioned button 1, the attendant mechanical work is converted to electrical power by known means 21, such as a piezoelectric crystal or electromagnetic generator. A microprocessor 12 senses the resulting input voltage and generates a series of voltage pulses of appropriate duration, in accordance with data contained in memory 13. A selector mechanism 14 is operated once during initial setup of the remote snooze button device of the present invention. In conjunction with data contained in memory 13, the settings of selector 14 influence the code that microprocessor 12 generates for appropriate control of target device 6. The voltage pulses thus generated cause a radio frequency antenna 17 to transmit a remote control signal that target device 6 can interpret as a “snooze” command. The required power for the generation and transmission of this control signal is also provided by transduction means 21. Again, it will be obvious to those skilled in the art that transduction means 21 would generally also incorporate means for temporary energy storage and power regulation.

A detail view of the underside of housing 2 is given in FIG. 9 for a preferred embodiment of the present invention, showing a series of discrete switches 31, of which the user chooses the positions once during initial set-up of the remote snooze button. Depending on the number of switches 31 and the number of positions that each switch may assume, a unique selection can be made among a number of different target devices supported by the remote snooze button. It is also possible to use the set of switches 31 to directly enter information on the actual device-specific control codes that need to be sent by the remote snooze button. Thereby, the set of switches 31 constitutes a preferred embodiment of the selector mechanism 14 shown in FIG. 4, 5, 7 and 8. Also shown in FIG. 9 is a battery door 32, which is an optional feature that is not shown in the alternative configurations of the underside of housing 2 in FIG. 10 and 11.

Another view of the underside of housing 2 is given in FIG. 10 for an alternative embodiment of the present invention, showing a rotary knob 33. The user chooses the position of this knob once during initial set-up of the remote snooze button of the present invention. Depending on the position of knob 33, a unique selection can be made among a number of different target devices supported by the remote snooze button. Thereby, knob 33 constitutes an alternative embodiment of the selector mechanism 14 shown in FIGS. 4, 5, 7 and 8.

Yet another view of the underside of housing 2 is given in FIG. 11 for a further alternative embodiment of the present invention, showing a solid-state memory card 34 being inserted into housing 2. This memory card either serves to identify the target device from among several possibilities, or contains information on the actual device-specific control codes that need to be sent by the remote snooze button. Thereby, memory card 34 constitutes an alternative embodiment of the selector mechanism 14 shown in FIGS. 4, 5, 7 and 8. In a similar vein, and as explained earlier, customization of the remote snooze button to a target device by way of “flashing” or other recording means, for instance in a factory, can also be understood as an implicit embodiment of selector 14.

Still another view of the underside of housing 2 is given in FIG. 12 for yet another alternative embodiment of the present invention, showing a switch 35 that places the device into a “learning” mode. While in this mode, infrared receiving diode 18 picks up a desired control code emitted by an original infrared remote control for target device 6 (not shown), and this code is committed to memory as explained earlier in the context of FIG. 6. Successful completion of this task is signaled to the user by indicator means 36, such as a buzzer or light. The user then places switch 35 back into the “operate” position so as to enable normal operation of the remote snooze button going forward.

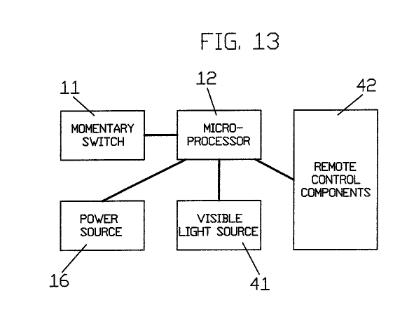

FIG. 13 is a schematic diagram showing an alternative embodiment of the present invention, which includes a visible light source 41 as part of the remote snooze button. Source 41 can be in the form of a light emitting diode (LED), or an incandescent or fluorescent light bulb. As with the embodiments previously described with reference to FIGS. 4 and 5, a switch 11 is momentarily closed when the user depresses button 1. Microprocessor 12, in response, coordinates the generation and emission of a remote control signal utilizing remote control components 42, here lumped together for convenience of description. An electrical power source 16, such as a battery, provides the required power to perform the generation and emission of this control signal. In this embodiment, the closing of switch 11 also triggers a change in the state of light source 41. This change in state may be in the form of a toggle, where each depression of button 1 turns the light source 41 on when it is off, and off when it is on. Alternatively, microprocessor 12 may allow light source 41 to turn off after a prescribed period of time when it is on, such that the user need not explicitly depress button 1 in order to turn off the light.

It will now be appreciated that a remote snooze button made in accordance with the teachings of the present invention will have a multiplicity of applications, including: conveniently and temporarily turning off a wake-up alarm on a remotely located target device, or sending a chosen control code other than “snooze” to the target device, as well as possibly providing a useful night light within easy reach of the user. Various modifications of the specific embodiments set forth above are also within the spirit and scope of the invention.

What is claimed is:

1. Apparatus for remotely sending a unique control code to a target device equipped to receive said control code, the apparatus comprising
a single button capable of being manually depressed, and which returns to its original position when the manual input is removed,
switch means connected to said single button,
a memory device,
selector means,
a source of electrical power,
a microprocessor,
radiation emission means, and
a housing to which said single button is moveably attached, and which contains said switch means, memory device, selector means, source of electrical power, microprocessor and radiation emission means,
wherein the microprocessor generates a control code in response to the actuation of the switch and causes the radiation emission means to emit said control code, and
wherein said control code is determined jointly by data contained in the memory device, and the selection made on said selector means.

2. The apparatus of claim 1 wherein the radiation emitted is infrared radiation.

3. The apparatus of claim 1 wherein the radiation emitted is radio frequency radiation.

4. The apparatus of claim 1 wherein the control code is a series of on-off pulses of prescribed durations.

5. The apparatus of claim 1 wherein the selector means is a set of discrete switches.

6. The apparatus of claim 1 wherein the selector means is a rotary knob.

7. The apparatus of claim 1 wherein the selector means is an insertable solid state memory device distinct from the primary memory device.

8. The apparatus of claim 1 wherein the source of electrical power is a battery.

9. The apparatus of claim 1 wherein the source of electrical power is mechanical to electrical transduction.

10. The apparatus of claim 9 wherein the mechanical to electrical transduction is achieved by means of a piezoelectric crystal.

11. The apparatus of claim 1 further comprising a source of visible light,
wherein the state of said visible light is controlled by the microprocessor in response to the actuation of said switch means.

12. Apparatus for remotely sending a unique control code to a target device equipped to receive said control code, the apparatus comprising
a single button capable of being manually depressed, and which returns to its original position when the manual input is removed,
switch means connected to said single button,
a memory device,
a source of electrical power,
a microprocessor,
radiation emission means, and
a housing to which said single button is moveably attached, and which contains said switch means, memory device, source of electrical power, microprocessor and radiation emission means,
wherein the microprocessor generates a control code in response to the actuation of the switch and causes the radiation emission means to emit said control code, and
wherein said control code is determined by data stored in the memory device in such a way as to match said control code to that required by a selected one of a plurality of supported target devices.

13. The apparatus of claim 12 wherein the radiation emitted is infrared radiation.

14. The apparatus of claim 12 wherein the radiation emitted is radio frequency radiation.

15. The apparatus of claim 12 wherein the control code is a series of on-off pulses of prescribed durations.

16. The apparatus of claim 12 further comprising a source of visible light,
wherein the state of said visible light is controlled by the microprocessor in response to the actuation of said switch means.

17. The apparatus of claim 12 further comprising infrared radiation receiving means,
wherein the microprocessor decodes, stores in said memory device, and replicates a control code received by said infrared receiving means.

18. The apparatus of claim 17 further comprising a second switch means,
wherein said infrared radiation receiving means is enabled or disabled depending on the position of said second switch means.

19. The apparatus of claim 18 further comprising a source of visible light,
wherein the state of said visible light is controlled by the microprocessor in response to the actuation of said switch means.
